(19) United States
(12) Patent Application Publication
(10) Pub. No.: US 2009/0123907 A1
(43) Pub. Date: May 14, 2009

(54) LYSINE CITRATE FOR PLASMA PROTEIN AND DONOR PROTECTION

(75) Inventor: Edward Shanbrom, Santa Ana, CA (US)

Correspondence Address: STEFAN KIRCHANSKI, VENABLE LLP 2049 CENTURY PARK EAST, 21ST FLOOR, LOS ANGELES, CA, 90067, US

(73) Assignee: Shanbrom Technologies, LLC, Ojai, CA (US)

(21) Appl. No.: 11/914,532

(22) PCT Filed: Jul. 22, 2005
(86) PCT No.: PCT/US05/26308

§ 371 Date: Sep. 24, 2008

Related U.S. Application Data
(63) Continuation-in-part of application No. 10/897,632, filed on Jul. 22, 2004, now abandoned.

(51) Int. Cl. A01N 1/02

(52) U.S. Cl. 435/2

(57) ABSTRACT

An improved anticoagulant or additive is based on a higher level of citric acid than is usual (at least about 1.0% weight by volume). The higher citrate is combined with an amino acid as a counterion. The amino acid prevents cellular damage often caused by elevated citrate levels. The amino acid citrate mixture also serves to preserve platelet concentrates and platelet rich plasma during room incubation. Not only does the amino acid citrate combination enhance platelet integrity, it completely inhibits or kills bacteria such as Staphylococcus epidermidis. Collecting blood of plasma into such higher levels of citrate prevents activation of blood proteins so that fractions made from the blood or plasma have superior characteristics.

The present application is a continuation-in-part of application Ser. No. 10/897,632, filed on 22 Jul. 2004. Priority is claimed from that application whose content is hereby incorporated by reference.

### BACKGROUND OF THE INVENTION

1. Area of the Art

The present invention is in the area of blood banking and compositions to preserve the viability of biological cells and more specifically for compositions to preserve the viability of blood cells and blood banking procedures based thereon.

2. Description of the Prior Art

Transfusion of whole blood and of components fractionated from whole blood is a common and well-accepted part of modern medical practice. Not only is blood transfused to replace losses due to accident or surgery, but also cellular components such as platelets are often transfused to correct disease-induced insufficiency of the cellular component.

Today we are accustomed to the idea of a blood bank where blood is removed from donors and stored and/or fractionated for later use. It comes somewhat as a surprise to realize that the first such blood banks were not established until the 1930's and did not become common in the United States until after the Second World War. Thus, the blood bank is only fifty or so years old as a common part of the medical scene. The relatively recent understanding of the factors required for successful blood transfusion explains this comparatively recent advent of blood banking.

One of the biggest problems in blood transfusion is the tendency of blood to clot once removed from the circulatory system. If blood is exposed to the atmosphere or comes into contact with any of a number of non-biological surfaces, the blood clotting reactions begin with the fluid becoming transformed into a gel. Many early attempts at transfusion resulted in the transfused blood becoming clotted—with more or less disastrous consequences for the recipient. We now know that exposure of blood to damaged tissues or foreign surfaces starts an “activation” process in which an incredible biochemical cascade in which specialized proteases in the blood cleave proenzymes to release or activate other proteases which activate other components, and so on and so on. Sodium citrate was first introduced in 1915 as an anticoagulant to prevent or slow this activation process. Within the next year or so glucose was added to the citrate to extend the life of anticoagulated blood.

By the 1920's the basic outlines of blood banking had been established. Blood is withdrawn from a donor's vein into a container holding concentrated sodium citrate and glucose to prevent activation of the clotting mechanism and to provide energy for the blood cells during storage. The stabilized blood is then stored under refrigeration and transfused into the vein of a donor after a cross-matching procedure indicted that the donor and recipient were compatible. It was not until 1979 that further improvements were made to anticoagulants. At that time CPDA-1 was introduced as an improved anticoagulant to replace ACD. CPDA-1 added adenine to the traditional anticoagulant allowing whole blood and red bloods cells to have a 35-day shelf life.

More recently whole blood donation has been partially replaced by “pheresis” techniques. The initial use of this method was probably “plasmapheresis” where a donor's plasma is removed while the cellular components are returned to the donor's circulatory system. Conceptually, the blood is removed from the patient, centrifuged to pellet the cellular components from the plasma. The plasma is removed from the pelleted cells and treated with an anticoagulant. The cellular components are resuspended in an isotonic diluent and retransfused into the patient. In this manner plasma can be removed from the patient without causing anemia or other conditions resulting from a shortage of cellular blood components. The missing plasma proteins are replaced fairly quickly.

Originally, plasmapheresis was used primarily as a therapy to lower the level of an abnormal antibody or other plasma protein (i.e., plasma exchange). With improvements in the method it is now used also as a source of plasma for fractionation or platelets (“plateletpheresis”) or white cells (leukapheresis) for transfusion. The major improvement has been specialized equipment that has changed plasmapheresis from a batch into a continuous flow, closed system process. Blood is withdrawn from the patient's vein and continuously separated into a cellular and plasma components (often with a zonal continuous flow centrifuge). In the case of complete plasmapheresis, the plasma is drawn off and the cellular components, resuspended in a diluent, are returned to the patient's circulatory system. A similar process is used with platelets except that additional centrifugal force is used to separate the platelets from the plasma. The platelets are then harvested in a special diluent and the plasma and cellular components are mixed to resuspend the cells and the mixture is returned to the patient.

Yet, there are many shortcomings in current blood banking practices. Perhaps the most pressing problem is the potential for spreading blood borne viruses and other pathogens. This problem is presently dealt with by screening tests and disinfection technology. A second problem is limits to shelf life due to contaminating bacteria. This is an especially acute problem with platelet concentrates, which generally must be stored at room temperature. Since it is virtually impossible to avoid some bacterial contamination when blood is withdrawn from a donor, platelet concentrates must be used in less than seven days to avoid an overgrowth of bacteria. In the “pheresis” systems it is necessary to add an anticoagulant to protect the plasma proteins and to prevent inadvertent intravascular coagulation of the components returned to the patient. Although most of the added anticoagulant stays with the plasma, because of the continuous flow nature of the process, a certain amount necessarily returns to the patient's circulation. Adding citrate to the patient's circulation causes a lowering of the effective calcium level (calcium activity) which can affect heart beat. As a result of the potential consequences of low calcium levels, “pheresis” donors are frequently administered extra calcium during the donation process. The problem of adding citrate to a patient's circulation is addressed in U.S. Pat. No. 6,368,785 to Ranby wherein a novel anticoagulant based on isocitric acid is disclosed. One of the advantages of that formulation is a higher calcium activity than traditional citrate-based anticoagulants. Ranby demonstrates that this lessens the problems caused in introducing the anti-coagulant into a patient's circulation.

Finally, there are growing indications that many of the fractions produced from donated blood are somewhat suboptimal. This may partly be due to damage occurring during the fractionation process itself. However, the present inventor believes that some problems are caused by low level or so-called cryptic activation of the clotting enzymes. Such activation is not sufficient to actually cause a clot, but the activated proteases cause damage to many blood proteins resulting in suboptimal properties to various blood fractions.

An inspection of the common anticoagulants used currently to collect blood shows that they all provide approximately 0.4% citrate by weight in the final anticoagulated solution. As explained below, there are valid data showing that a higher level of citrate than 0.4% citrate prevents or greatly reduces cryptic activation of enzymes. However, the present anticoagulants were formulated to give maximum blood cell life, which also means that the anticoagulant must cause negligible cell damage. Levels of sodium citrate (or soluble citrate salts of other metallic cations) that are appreciably higher than 0.4% citrate by weight (say about 0.8% or higher) can cause significant cellular damage. Because there is a pervasive belief that 0.4% citrate is more than adequate. Therefore, the anticoagulants were optimized to prevent cell damage with little regard for cryptic activation of blood proteins. In addition, similar citrate-based anticoagulants are used in “pheresis” systems. Any increase in the level of citrate results in more citrate being returned to the donor with a concomitant need to monitor and possibly augment circulating calcium levels.

### SUMMARY OF THE INVENTION

Fractions made from blood and plasma anticoagulated with an improved anticoagulant are superior because activation and resulting protein damages are avoided. Optimum anticoagulation requires a higher level of citrate—about 0.8% to 2.0% by weight or greater. However, elevated citrate levels may result in damage to cellular components—red blood cells and platelets, especially, and to problems with excess citrate being returned into donor circulation when plasmapheresis and similar systems are employed. Surprisingly providing the elevated citrate in the form of a citrate salt of a basic amino acid avoids both problems. Citrate amino acid anticoagulant not only prevents red cell damage, it inhibits bacterial growth in room temperature platelet concentrates while preserving platelet structure and function. Citrate amino acid anticoagulant provides a higher effective calcium level so that even when more citrate is returned to the donor in plasmapheresis systems there is a lesser effect because the amino acid citrate combination provides a higher level of calcium activity. The properties of the novel compounds lysine citrate and arginine citrate also make them useful to membrane fractionation and concentration of labile protein solutions.

Following collection at optimal citrate levels still higher citrate concentrations can be use to produce enhanced cryoprecipitate. Such cryoprecipitate is free from activation damage and can be used to produce fibrin glue or sealant. The cryo-depleted plasma can then be fractionated into an albumin and an immunoglobulin fraction. These fractions show superior properties because the source plasma has never become even slightly activated.

The improved anticoagulant used directly in blood collection or as an additive to collected blood as well as related procedures are especially amenable to use in a hospital blood bank because they are relatively simple to carry use. The resulting products can be readily used within the hospital and can also represent an enhanced source of revenue for the blood bank.

### DESCRIPTION OF THE FIGURES

FIG. 1 is a flow diagram showing the fractionation of cryo-depleted plasma according the present invention.

### NOT FURNISHED UPON FILING was ultimately cleaved to release D-dimers. That is, D-dimers are an indication of past activation of enzymes in a sample.

To demonstrate the presence of cryptic activation 34 freshly drawn, citrated plasma samples (standard 0.4% sodium citrate anticoagulant) were obtained. The samples were divided into four 1 ml aliquots. To three of the sample aliquots, sufficient concentrated citrate solution was added to achieve 1%, 1.5% or 2% weight/volume citrate, respectively, while the fourth aliquot acted as the control.

As a “worst case” scenario to detect activation, the aliquots were incubated at 21° C. for a maximum of ten days. Each aliquot was assayed daily for the presence of D-dimers using the DimerTest latex agglutination assay (American Diagnostica, Stamford, Conn.). The results are shown in Table 1 where the number of days to observable D-dimers is listed for each aliquot. In the table “n/a” means that no D-dimers were ever observed, thus indicating that no activation has occurred in that sample. At day six of incubation, 41.2% (14) of the control aliquots were positive for the presence of D-dimers. By day seven, 100% (34) of the normal citrate (0.4%) aliquots were positive for D-dimers. None of the samples showed visible clots. None of the aliquots with additional citrate showed D-dimers by day ten of the incubation period. These results demonstrate that traditional levels of citrate are inadequate to completely suppress clotting enzyme activation.

TABLE 1

| | 0.4% | 1% | 1.5% | 2% |
|---|---|---|---|---|
| Sample | Citrate | Citrate | Citrate | Citrate |
| #1 | 6 | n/a | n/a | n/a |
| #2 | 7 | n/a | n/a | n/a |
| #3 | 7 | n/a | n/a | n/a |
| #4 | 7 | n/a | n/a | n/a |
| #5 | 7 | n/a | n/a | n/a |
| #6 | 6 | n/a | n/a | n/a |
| #7 | 7 | n/a | n/a | n/a |
| #8 | 6 | n/a | n/a | n/a |
| #9 | 6 | n/a | n/a | n/a |
| #10 | 7 | n/a | n/a | n/a |
| #11 | 6 | n/a | n/a | n/a |
| #12 | 6 | n/a | n/a | n/a |
| #13 | 7 | n/a | n/a | n/a |
| #14 | 7 | n/a | n/a | n/a |
| #15 | 7 | n/a | n/a | n/a |
| #16 | 7 | n/a | n/a | n/a |
| #17 | 7 | n/a | n/a | n/a |
| #18 | 7 | n/a | n/a | n/a |
| #19 | 6 | n/a | n/a | n/a |
| #20 | 7 | n/a | n/a | n/a |
| #21 | 7 | n/a | n/a | n/a |
| #22 | 7 | n/a | n/a | n/a |
| #23 | 7 | n/a | n/a | n/a |
| #24 | 6 | n/a | n/a | n/a |
| #25 | 6 | n/a | n/a | n/a |
| #26 | 7 | n/a | n/a | n/a |
| #27 | 6 | n/a | n/a | n/a |
| #28 | 5 | n/a | n/a | n/a |
| #29 | 6 | n/a | n/a | n/a |
| #30 | 7 | n/a | n/a | n/a |
| #31 | 6 | n/a | n/a | n/a |
| #32 | 7 | n/a | n/a | n/a |
| #33 | 6 | n/a | n/a | n/a |
| #34 | 7 | n/a | n/a | n/a |

Since it is clear that higher levels of citrate are needed to prevent cryptic activation, the inventor set out to find a way to achieve the benefits of higher citrate concentrations without causing cellular damage. When levels of citrate are used that are significantly above the standard 0.4% by weight, there is swelling of the red cells and/or release of enzymes and hemoglobin from the red cells—all these changes are indicative of some type of damage to the cell. It was suspected that the problem might be that red cell membranes have mechanisms that allow the penetration of cations like sodium as well as mechanisms allowing uptake of citrate. This results in an osmotic imbalance if the cells take up both sodium and citrate. If a non-permeable counterion to citrate could be used, citrate uptake might be severally limited due charge considerations.

Following this line of reasoning various counterions to citrate were considered. Although those of skill in the art of organic chemistry can point to a large number of suitable water-soluble anionic counterions for use with citric acid, the goal of the present invention is to use the citrate treated blood for transfusion and “pheresis” applications; therefore, many potential counterions cannot be used, at least not until safety studies are undertaken. One apparently safe type of counterion would be a basic amino acid since such a compound is water soluble, non-toxic and believed to be safe for intravenous administration. Experiments have been carried out with both novel compounds—lysine citrate and arginine citrate; the results are comparable so most experiments now use only lysine citrate to simplify the tests.

The inventive compound can be used in at least two ways. It can be used to completely replace the traditional sodium citrate anticoagulant or it can be used as an “additive” solution to augment the normal sodium citrate anticoagulant. Since activation and other changes and deterioration of blood proteins and cells takes place over a period of time, it is possible to collect the blood into traditional sodium citrate (0.4% by weight) and then to augment the citrate level (to at least about 0.8-1% by weight and in some applications to at least about 2% by weight citrate). This allows one to use available apparatus (e.g., blood bags) containing traditional sodium citrate and yet realize the advantages of the new amino acid-citrate compound. An effective stock solution for use either directly or as an additive can be prepared as follows. A 10% weight by volume solution of citric acid is prepared by dissolving anhydrous citric acid in deionized or distilled water. If non-anhydrous (that is, material having water of crystallization) citric acid is used, the weight of the added citric acid is adjusted so that the solution is 10% by weight citric acid molecules. The pH of the solution is then adjusted to 7.0±0.1 by adding L-lysine. The final concentration of lysine is approximately 0.25 mg/ml. It will be appreciated that different applications may use different final pH values, usually between about pH 6.0 and pH 8.0, and that the amount of lysine or other basic amino acid will vary accordingly. The lysine or arginine amount is simply adjusted to achieve the desired pH. It will be appreciated that the amino acid citrate composition can be used in all types of blood collection which includes plasmapheresis and related “pheresis” procedures.

### Stabilization of Proteins

As the basic anticoagulant experiments were carried out, additional advantages to the new anticoagulation system became apparent. The inventor has long believed that the effects of citrate on proteins, and in particular plasma proteins, goes beyond mere chelation of calcium. As mentioned above, citrate complexes with or otherwise potentiates the precipitation of plasma proteins. Previous experiments have indicated that presence of citrate may protect proteins from denaturation. Soluble protein can be denatured by vigorous mixing and the resulting exposure to the air-water interfaces present in foam. In the experiment presented here normally anticoagulated plasma (0.4% by weight citrate in the form of sodium citrate) was compared to 2% by weight citrate (achieved by adding lysine-citrate stock to the 0.4% sodium citrate plasma). Two ten ml tubes of each plasma were prepared and held at room temperature for thirty minutes. A “pretreatment” sample (Pre) was removed from each tube and set aside. Then the tubes were subjected to vigorous mixing using a vortex (rotary) mixer for 30 min. Each treated tube showed persistent foam and the normally anticoagulated sample appeared very slightly hazy.

As is shown Table 2 There is a considerable difference in the stability of various plasma proteins to denaturation in the presence of normal anticoagulant as opposed to lysine-citrate anticoagulant. Alkaline phosphatase (Alk. Phos.) was reduced to 55% of its initial value in normally anticoagulated plasma while it was reduced to 88% of its initial value in the lysine-citrate sample. The comparison of SGOT (serum glutamic oxalacetic transaminase) showed 6.6% versus 91.6%; SGPT (serum glutamic pyruvic transaminase) showed 3.4% versus 92%; LDH (lactate dehydrogenase) showed 33% versus 80%; factor VIII (a clotting factor) showed 31% versus 59%; factor V (another clotting factor) showed 21% versus 58%; factor IX (a third clotting factor) showed 43% versus 77.6%; while fibrinogen showed 4% versus 80%. In all cases lysine citrate showed considerably less protein denaturation than the normal sodium citrate anticoagulant. The question then arises is the effect primarily due to the higher citrate concentration (2% by weight versus 0.4% by weight)? A similar experiment was performed (data not shown) comparing 2% lysine citrate to 2% sodium citrate. While the lysine citrate results were comparable to the experiment reported in Table 2, the 2% sodium citrate recoveries were much better than the results with 0.4% sodium citrate (alkaline phosphatase was 80% of the initial value; SGOT was 33%; SGPT was 32%; LDH was 48%; factor Viii was 57%; factor V was 52%; factor IX was 62% and fibrinogen was 69%), thereby demonstrating the positive influence of higher citrate concentrations. However, those results were all lower than the recovery for the corresponding protein with 2% lysine citrate. This indicates that the combination of lysine and citrate provides enhanced protein protection as compared to an equivalent concentration of citrate.

TABLE 2
Protein resistance to vortexing in 0.4% sodium citrate versus
2.0% lysine citrate.

| | Na Citrate | Na Citrate | Lysine Citrate | Lysine Citrate |
|---|---|---|---|---|
| | Pre | Post | Pre | Post |
| Alk. Phos | 27 | 15 | 25 | 22 |
| (IU/.L) | | | | |
| SGOT (IU/L) | 15 | 1 | 12 | 11 |
| SGPT (IU/L) | 29 | 1 | 26 | 24 |
| LDH (IU/L) | 100 | 33 | 99 | 80 |
| fVIII (%) | 102 | 32 | 97 | 57 |
| fV (%) | 98 | 21 | 95 | 55 |
| fIX (%) | 103 | 44 | 98 | 76 |
| fibrinogen | 258 | 106 | 247 | 198 |
| (mg/dl) | | | | |

The above experiment was repeated using glass beads as a denaturing agent. Generally, contact of blood plasma with glass surfaces results in activation or denaturation. One gram of glass beads (400-600 μm mean diameter) was added to each treatment tube and mixed by rocking for 30 min. Following the experimental treatment, the 0.4% sodium citrate tubes appeared slightly cloudy while the 2% lysine citrate tubes appeared unchanged. These results are shown in Table 3. A number of the proteins in 0.4% sodium citrate showed increased sensitivity to denaturation by glass beads (as compared to denaturation by vortexing) while several of the proteins in 2% lysine citrate were actually more resistant to denaturation by glass beads as compared to denaturation by vortexing.

TABLE 3
Protein resistance to glass beads in 0.4% sodium citrate versus
2.0% lysine citrate.

| | Na Citrate | Na Citrate | Lysine Citrate | Lysine Citrate |
|---|---|---|---|---|
| | Pre | Post | Pre | Post |
| Alk. Phos | 27 | 16 | 25 | 24 |
| (IU/.L) | | | | |
| SGOT (IU/L) | 15 | 1 | 12 | 12 |
| SGPT (IU/L) | 29 | 1 | 26 | 24 |
| LDH (IU/L) | 100 | 24 | 99 | 96 |
| fVIII (%) | 102 | 29 | 97 | 62 |
| fV (%) | 98 | 15 | 95 | 67 |
| fIX (%) | 103 | 14 | 98 | 84 |
| fibrinogen | 258 | 88 | 247 | 202 |
| (mg/dl) | | | | |

The protective ability of the improved lysine-citrate anticoagulant was also tested in a “pasteurization” context. In many cases heat treatments have been used to reduce or eliminated infectious agents from blood products. A problem with such an approach has been heat induced changes in the antigenicity of certain blood components. In this experiment 0.4% sodium citrate anticoagulated plasma was compared to 2% lysine citrate anticoagulated plasma in terms of the ability of the proteins to withstand heating to 56° C. for five minutes. Table 4 shows the differences in fresh plasma heated with 0.4% sodium citrate anticoagulant versus 2% lysine citrate anticoagulant. These results demonstrate the considerable protective effect that lysine citrate exerts. This is particularly dramatic in the case of fibrinogen where almost all of the fibrinogen in the sodium citrate sample was denatured by the increased temperature. A continuation of this experiment was set up to check also long term room temperature stability. It is generally believed that resistance to heat is an indicator of room temperature stability. That is the justification for estimating long term stability of products by using “accelerated” stability tests based on storage at an elevated temperature. In the presented experiment it is important to note that different plasma sample were used for the two different anticoagulants because a single sample was not large enough to provide sufficient volume for all of the tests over the life of the extended experiment.

TABLE 4
Protein resistance to 56° C. treatment in 0.4% sodium citrate
versus 2.0% lysine citrate.

| | | Na Citrate | Lysine | Lysine Citrate |
|---|---|---|---|---|
| | Na Citrate | Post 56° C. | Citrate | Post 56° C. |
| Alk. Phos (IU/.L) | 30 | 23 | 23 | 16 |
| SGOT (IU/L) | 18 | 15 | 10 | 7 |
| SGPT (IU/L) | 32 | 21 | 20 | 17 |
| LDH (IU/L) | 110 | 84 | 97 | 91 |
| fVIII (%) | 109 | 56 | 102 | 88 |
| fV (%) | 98 | 45 | 97 | 69 |
| fIX (%) | 104 | 67 | 99 | 79 |
| fibrinogen (mg/dl) | 206 | 15 | 198 | 147 |

It was anticipated that protection against damage due to elevated temperature would also provide greater stability at room temperature. It will be appreciated that the need to rapidly freeze plasma to ensure stability and the need to freeze or refrigerate plasma for transport greatly complicates the use of plasma under situations of war or emergency or in developing countries where refrigeration may not be readily available. Table 5 shows the survival of enzymes in plasma stored at room temperature for 7, 14, and 21 days. These results show that the blood proteins are strikingly more stable in lysine citrate (2%) than in sodium citrate (0.4%). It is believed that the primary effect is due to the denaturation protection offered by lysine citrate. However, as explored below in reference to platelet preservation, lysine citrate also has bacteriostatic and bactericidal properties. Although great effort is taken to ensure sterility of the plasma, any blood product procured by means of venipuncture may become contaminated by skin bacteria. Lysine citrate provides extra insurance against growth of bacteria further increasing the feasibility of room temperature plasma storage. The data demonstrate that many proteins lose essentially no activity over a three week period of room temperature storage in lysine citrate. Those proteins that do lose activity decrease only slightly as compared to much more dramatic decreases in sodium citrate storage.

TABLE 5
Protein resistance to room temperature aging.

| | Na | Na | Na | Na | Ly | Ly | Ly | Ly |
|---|---|---|---|---|---|---|---|---|
| | Citrate | Citrate | Citrate | Citrate | Citrate | Citrate | Citrate | Citrate |
| | 0 days | 7 days | 14 days | 21 days | 0 days | 7 days | 14 days | 21 days |
| Alk. Phos | 30 | 29 | 31 | 28 | 23 | 23 | 22 | 23 |
| (IU/.L) | | | | | | | | |
| SGOT | 18 | 18 | 15 | 12 | 10 | 10 | 11 | 10 |
| (IU/L) | | | | | | | | |
| SGPT | 32 | 30 | 26 | 20 | 20 | 20 | 20 | 18 |
| (IU/L) | | | | | | | | |
| LDH | 110 | 111 | 108 | 103 | 97 | 97 | 98 | 98 |
| (IU/L) | | | | | | | | |
| fVIII (%) | 109 | 100 | 92 | 78 | 102 | 100 | 97 | 96 |
| fV (%) | 98 | 102 | 102 | 44 | 97 | 95 | 92 | 88 |
| fIX (%) | 104 | 107 | 93 | 56 | 99 | 100 | 95 | 89 |
| fibrinogen | 206 | 181 | 173 | 167 | 198 | 198 | 196 | 196 |
| (mg/dl) | | | | | | | | |

### Preservation of Platelets

A major application of the inventive compound is as an anticoagulant/preservative in platelet concentrates for transfusion purposes. Platelet transfusions are necessary in the treatment of a wide variety of diseases and especially in cancer therapies where chemo or radiation therapy impairs a patient's ability to produce platelets. A major problem with platelets is that platelets are damaged by low temperatures so the concentrates must generally be stored at room temperature. Room temperature storage encourages the growth of any bacteria that may be present. As a result there is a significant danger of causing septicemia if a fragile patient receives bacterially tainted platelets. To limit this danger platelets for transfusion are extensively tested for contamination and storage of the platelet concentrates is limited to five days. In reality uncontaminated platelets can be stored for seven or eight days before natural aging of the platelets makes them undesirable for transfusion. A tremendous number of platelet units must be discarded after five days so that extending the shelf life by even two days would greatly extend the available platelet supply.

In the experiment anticoagulated blood (0.4% citrate by weight) was centrifuged to produce platelet Rich Plasma (PRP). To test samples of PRP citric acid stock solution containing sufficient lysine to bring the solution pH to 7.0 was added to increase the citrate concentration to 1% by weight. Following this addition the pH of the mixture was 6.7. It will be apparent to one of skill in the art that the precise ratio of basic amino acid to citrate can be altered to adjust the pH of the either the stock solution or the final blood mixture. One sample of original PRP was used as the Normal Control, and one sample of the lysine citrate PRP was used as the Citrate Control. One sample of original PRP was inoculated with cultured Staphylococcus epidermidis to a final concentration of about 10 cfu/ml—this formed the Spiked Normal. Similarly, one aliquot of lysine citrate PRP was inoculated with Staphylococcus epidermidis to a final concentration of about 10 cfu/ml to form the Spiked Citrate. The samples were incubated at room temperature for five days. Each day the number of platelets in each sample was counted; each sample was also tested for LDH (lactate dehydrogenase) and for the ability to induce a clot. Following the tests an aliquot of each sample was subcultured on nutrient agar and incubated under growth conditions. The results of the non-bacteriological tests are given below in Table 6 while the bacteriological tests are shown in Table 7.

TABLE 6

| | | Normal Control | Spiked Normal | Citrate Control | Spiked Citrate |
|---|---|---|---|---|---|
| Day 1 | Count (per μl) | 3.1 × 10⁵ | 3 × 10⁵ | 3.2 × 10⁵ | 2.99 × 10⁵ |
| | LDH (IU/L) | 130 | 128 | 133 | 131 |
| | Clot time (sec) | 32 | 30 | 35 | 29 |
| Day 2 | Count | 3.0 × 10⁵ | 2.9 × 10⁵ | 3.1 × 10⁵ | 3.0 × 10⁵ |
| | LDH | 131 | 130 | 133 | 130 |
| | Clot time | 32 | 30 | 30 | 32 |
| Day 3 | Count | 3.1 × 10⁵ | 2.5 × 10⁵ | 3.3 × 10⁵ | 3.0 × 10⁵ |
| | LDH | 140 | 143 | 134 | 133 |
| | Clot time | 35 | 39 | 32 | 30 |
| Day 4 | Count | 3.3 × 10⁵ | 1.9 × 10⁵ | 3.5 × 10⁵ | 3.2 × 10⁵ |
| | LDH | 143 | 158 | 133 | 131 |
| | Clot time | 36 | 60 | 35 | 30 |
| Day 5 | Count | 3.2 × 10⁵ | 1.5 × 10⁵ | 3.1 × 10⁵ | 3.0 × 10⁵ |
| | LDH | 149 | 188 | 135 | 131 |
| | Clotting time | 38 | >120 | 33 | 32 |

TABLE 7

| Colony Counts | Day 1 | Day 2 | Day 3 | Day 4 | Day 5 |
|---|---|---|---|---|---|
| Normal Control | 0 | 0 | 0 | 0 | 0 |
| Spiked Normal | 10 | 200 | >250 | >250 | >250 |
| Spiked Citrate | 10 | 7 | 5 | 9 | 7 |

Table 6 shows that the platelet count for the Normal Control remained essentially unchanged over the five-day period. This is consistent with current procedure that permits platelet concentrates to be stored for as long as five days. However, over this time there was an increase of LDH (which leaks from damaged platelets) and a slight increase in clotting time, most likely a reflection of damaged platelets. In the Spiked Normal the number of platelets declined significantly while the LDH and clotting time increased greatly—all these signifying the deterioration of the platelets due to bacterial growth. In the Citrate Control, the number of platelets, LDH level and clotting time remained essentially unchanged over the five-day period demonstrating the preservative effect of the amino acid citrate combination. Even more significant is the measurement of the Spiked Citrate over the five days—like the Citrate Control, the various criteria remained essentially unchanged.

Table 7 provides further insight. The Normal Control showed no bacteria when plated out. This indicates that the PRP in this experiment is essentially axenic—something that is not at all guaranteed with collected blood. Therefore, the slight deterioration seen over the five days should be due entirely to platelet damage (possibly from the anticoagulant) or aging of the platelets as opposed to an effect of bacterial contaminants. The Spiked Normal shows tremendous bacterial growth after the second day as might be expected. This shows why the normal contamination of blood samples with Staphylococcus epidermidis is such a huge problem. If only a few bacterial cells from the donor skin surface get mixed into the blood, the samples can be essentially destroyed within a few days. Just like the Normal Control, the Citrate Control showed no bacteria following plating onto nutrient agar. The Spiked Citrate results, however, are very interesting because essentially the same small number of bacteria is recovered each day. This indicates that while the amino acid citrate does not kill the added bacteria, it essentially completely inhibits their growth. Thus, addition of amino acid citrate to platelets preserves platelet functions and prevents multiplication of any contaminating bacteria. Since the platelets are essentially completely unchanged after five days, amino acid citrate treatment can readily extend the life of platelet concentrate to seven days, if not much longer. Since the amino acid citrate stabilizes the platelets and inhibits bacterial growth, it is anticipated that addition of growth factors or energy sources (e.g., sugars) will further extend platelet life. Formerly, such additions were not possible, as they would merely accelerate bacterial growth.

Additional experiments indicated that higher levels of citrate are bactericidal as well as bacteriostatic. In addition, as already demonstrated higher levels of lysine citrate show improved preservation of many plasma proteins. In this experiment 10 ml plasma samples were inoculated with either 10² or 10³ cfu/ml of bacteria as indicated in Table 8. Immediately each sample was brought to 2% by weigh citrate in the form of lysine citrate from a 20% by weight lysine citrate stock solution prepared as explained earlier. Each sample was incubated overnight at 37° C. An aliquot of each sample was plated on trypicase soy agar and again incubated over night at 37° C. and then counted. The number of actual colonies counted versus the expected number of colonies was used to calculate the log reduction in the number of bacteria. If the lysine citrate is completely bactericidal against the organism one would expect to determine a log reduction equal to the number of initial organisms. That is, if 10² (2 logs) organisms were originally introduced into the sample and all of the organisms were killed by the lysine citrate, a reduction of 2 logs would be determined. Complete destruction of 10³ (3 logs) of an organism would be shown by a 3 log reduction. It should be appreciated that the higher the initial load of bacteria, the more difficult it will be for lysine citrate to achieve a complete kill. In real like the level of initial bacterial contamination would be far lower than 10² cfu/ml.

TABLE 8
Bactericidal activity of 2% lysine citrate.

| 10² cfu/ml | Log reduction | 10³ cfu/ml | Log reduction |
|---|---|---|---|
| Staphylococcus | 2 | Staphylococcus | 3 |
| epidermidis (+) | | epidermidis (+) | |
| Bacillus cereus | 2 | Bacillus cereus | 3 |
| (+) | | (+) | |
| Escherichia | 2 | Escherichia | 2.8 |
| coli (−) | | coli (−) | |
| Yersinia | 2 | Yersinia | 3 |
| enterocolitica (−) | | enterocolitica (−) | |
| Pseudomonas | 2 | Pseudomonas | 2.7 |
| fluorescens (−) | | fluorescens (−) | |
| Serratia | 0 | Serratia | 0 |
| marcescens (−) | | marcescens (−) | |

The scientific names of each bacterium are followed by an indication as to whether the species is gram-negative (−) or gram-positive (+) since this characteristic often correlates with the sensitivity of the species to various agents. The results show that both gram-positive and gram-negative organisms are completely destroyed by 2% lysine citrate when a 2 log inoculation is used. With a 3 log inoculation E. coli and P. fluorescens show almost but not quite complete reduction. It appears that Serratia marcescens is not killed by the 2% lysine citrate; however, this bacterium is prevented from growing by the lysine citrate.

Experiments were undertaken to evaluate the effects of higher levels of lysine citrate on platelets. In a first experiment shown in Table 9. In this experiment plasma is centrifuged to create platelet rich plasma (PRP). Lysine citrate was added to bring the citrate concentration to 2%. The platelet concentrate was stored at room temperature and analyzed daily for 25 days as shown in table. For the first fifteen days the platelet parameters remain essentially unchanged. During the next five day period (days 16-20) the platelet count drifts down slightly and LDH level increases slightly. During the last five days (days 21-25), the platelet count drops off rather precipitously and the LDH level rises rather steeply. Yet clotting time remains relatively constant. This suggests that the fall in platelet count at least partially due to clumping of the platelets rather than lysis.

TABLE 9
Platelet rich plasma supplemented with 2% lysine citrate.

| | Day: | | | | |
|---|---|---|---|---|---|
| | 1 | 2 | 3 | 4 | 5 |
| Count | 3.80 × 10⁵ | 3.75 × 10⁵ | 3.76 × 10⁵ | 3.80 × 10⁵ | 3.76 × 10⁵ |
| (per μl) | | | | | |
| LDH (IU/L) | 106 | 108 | 109 | 108 | 108 |
| Clotting | 30 | 30 | 30 | 30 | 31 |
| time (sec) | | | | | |
| pH | 7.4 | 7.4 | 7.4 | 7.3 | 7.4 |
| | Day: | | | | |
| | 6 | 7 | 8 | 9 | 10 |
| Count | 3.75 × 10⁵ | 3.76 × 10⁵ | 3.76 × 10⁵ | 3.80 × 10⁵ | 3.77 × 10⁵ |
| LDH | 106 | 109 | 109 | 108 | 109 |
| Clotting | 31 | 32 | 30 | 31 | 30 |
| time (sec) | | | | | |
| pH | 7.3 | 7.4 | 7.4 | 7.5 | 7.5 |
| | Day: | | | | |
| | 11 | 12 | 13 | 14 | 15 |
| Count | 3.77 × 10⁵ | 3.75 × 10⁵ | 3.81 × 10⁵ | 3.80 × 10⁵ | 3.76 × 10⁵ |
| LDH | 109 | 108 | 110 | 110 | 109 |
| Clotting | 29 | 30 | 30 | 31 | 30 |
| time (sec) | | | | | |
| | 7.4 | 7.5 | 7.5 | 7.4 | 7.4 |
| | Day: | | | | |
| | 16 | 17 | 18 | 19 | 20 |
| Count | 3.75 × 10⁵ | 3.74 × 10⁵ | 3.76 × 10⁵ | 3.74 × 10⁵ | 3.74 × 10⁵ |
| LDH | 109 | 108 | 110 | 111 | 111 |
| Clotting | 29 | 30 | 30 | 31 | 30 |
| time (sec) | | | | | |
| pH | 7.4 | 7.5 | 7.6 | 7.5 | 7.6 |
| | Day: | | | | |
| | 21 | 22 | 23 | 24 | 25 |
| Count | 3.56 × 10⁵ | 3.42 × 10⁵ | 3.28 × 10⁵ | 2.91 × 10⁵ | 2.24 × 10⁵ |
| LDH | 103 | 105 | 122 | 159 | 279 |
| Clotting | 30 | 31 | 26 | 29 | 26 |
| time (sec) | | | | | |
| pH | 7.6 | 7.5 | 7.6 | 7.7 | 7.6 |

The second experiment was similar to the first platelet experiment reported above with the primary difference that the primary anticoagulant was CPD (citrate-phosphate-dextrose). This anticoagulant contains approximately 0.4% citrate by weight but also contains dextrose as an energy source for the platelets (and also, unfortunately, for any bacteria that may be present). PRP was prepared and lysine-citrate stock solution was added to bring the final citrate concentration to 2% by weight. The platelet concentrate was stored at room temperature and analyzed daily for 15 days as shown in Table 10. It was believed that the CPD might further stabilize the platelets by providing an energy source.

TABLE 10
Platelets in 2% lysine citrate and CPD.

| | Day: 1 | | | | |
|---|---|---|---|---|---|
| | 1 | 2 | 3 | 4 | 5 |
| Count | 2.41 × 10⁵ | 2.41 × 10⁵ | 2.40 × 10⁵ | 2.40 × 10⁵ | 2.38 × 10⁵ |
| (per μl) | | | | | |
| LDH (IU/L) | 98 | 96 | 97 | 98 | 99 |
| Clotting | 29 | 30 | 30 | 31 | 32 |
| time (sec) | | | | | |
| pH | 7.4 | 7.4 | 7.4 | 7.3 | 7.4 |
| | Day 4 | | | | |
| | 6 | 7 | 8 | 9 | 10 |
| Count | 2.41 × 10⁵ | 2.42 × 10⁵ | 2.40 × 10⁵ | 2.38 × 10⁵ | 2.38 × 10⁵ |
| LDH | 101 | 100 | 102 | 100 | 98 |
| Clotting | 30 | 28 | 28 | 31 | 30 |
| time (sec) | | | | | |
| pH | 7.4 | 7.4 | 7.4 | 7.5 | 7.5 |
| | Day 7 | | | | |
| | 11 | 12 | 13 | 14 | 15 |
| Count | 2.35 × 10⁵ | 2.34 × 10⁵ | 2.34 × 10⁵ | 2.35 × 10⁵ | 2.28 × 10⁵ |
| LDH | 103 | 101 | 103 | 105 | 122 |
| Clotting | 29 | 30 | 30 | 31 | 26 |
| time (sec) | | | | | |
| | 7.4 | 7.4 | 7.6 | 7.5 | 7.6 |

These results again show that the platelet measurements are surprisingly stable in 2% lysine citrate. For the first ten days the measurements are essentially unchanged. There appears to be a slight downward drift in platelet count accompanied by a slight increase in LDH and a slight upward trend in pH. The clotting time is essentially unchanged. In the next five days (day 11 to day 15), these trends continue with a more pronounced drop in platelet count at day 15 accompanied by an apparent sharp increase in LDH. In this experiment, at least, the added CPD did not extend platelet life beyond that provided by 2% lysine-citrate alone.

### Preservation of Red Blood Cells

As demonstrated above, collection of blood into levels of citrate significantly higher than the traditional 0.4% by weight results in significant reduction in activation of plasma proteins. However, significantly increasing the level of sodium citrate also results in red blood cell damage. In this experiment whole blood (an aliquot of which clotted within 10 minutes without anticoagulant) was modified by adding a number of different anticoagulant compositions. Sodium citrate was used as an anticoagulant at 0.65%, 0.75% and 0.9% by weight. These are all higher citrate levels than the usual 0.4% by weight. Amino acid citrates (lysine or arginine) were used at 0.65%, 0.75% and 0.9% by weight based on the weight of the citric acid. The amino acid counterion was used in sufficient quantity to adjust the pH as explained above. Table 11 shows the clotting times (PT=prothrombin time and PTT=partial prothrombin time) for the anticoagulated bloods after four hours storage at room temperature.

TABLE 11

| | PT (seconds) | PTT (seconds) |
|---|---|---|
| Anticoagulant | (4 hrs at RT) | (4 hrs at RT) |
| Na Citrate | 13.1 | 28.7 |
| 0.65 wgt %. | | |
| Na Citrate | 14.1 | 31.5 |
| 0.75 wgt %. | | |
| Na Citrate | 21.2 | 35.0 |
| 0.90 wgt %. | | |
| Arg Citrate | 15.8 | 36.8 |
| 0.65 wgt %. | | |
| Arg Citrate | 20.2 | 39.9 |
| 0.75 wgt %. | | |
| Arg Citrate | 55 | 56.8 |
| 0.90 wgt %. | | |
| Lys Citrate | 14.1 | 33.8 |
| 0.65 wgt %. | | |
| Lys Citrate | 16.6 | 33.2 |
| 0.75 wgt %. | | |
| Lys Citrate | 36.5 | 44.4 |
| 0.90 wgt %. | | |

The normal PT clotting time is about 11-13 seconds, and the normal PTT clotting time is less than about 33 seconds. Therefore, PT clotting time for the 0.65% sodium citrate was about normal. All of the other anticoagulants showed clotting times slightly to significantly longer than normal. Both of the amino acid citrate anticoagulants are more effective anticoagulants than sodium citrate (as judged by ability to inhibit clot formation in this test). This is somewhat surprising because, as demonstrated below, the amino acid citrate combinations actually chelate calcium ions less tightly than equivalent sodium citrate concentrations. Since the available calcium ion level is higher, one might expect the anticoagulant to be less effective. This suggests that the lysine as well as the citrate have an anticoagulating effect.

Table 12 shows the effective level of calcium measured in blood in the presence of different citrate based anticoagulants. Lysine citrate is compared to traditional sodium citrate. The various citrate levels are expressed as a weight percentage of citrate so that equivalent levels have the same amount of citrate. The same blood was used throughout so that all of the samples started with the same calcium concentration. Since citrate is an effective chelator of calcium one expects the measured level of calcium to decrease with increasing levels of citrate as more and more of the calcium is “tied up” by the citrate. There is an equilibrium between free measurable calcium and calcium associated with citrate molecules. As the concentration of citrate is increased, calcium levels are lowered as there is a higher and higher probability that a given calcium ion will be interacting with a citrate molecule. The results show that for equal concentrations of citrate, the measurable calcium levels are higher with lysine citrate than with sodium citrate. There are at least two different ways of interpreting phenomenon. It is possible that when lysine molecules interact with citrate molecules, the interaction somehow prevents the chelation of calcium. This would explain the higher calcium measurements because there would effectively be a lower level of citrate present. However, this certainly fails to explain the observation that lysine citrate is a more effective anticoagulant at a given citrate level. A second and related way of interpreting this result is to consider that the citrate lysine interaction lowers the equilibrium interaction or binding constant between calcium and citrate. That too would explain the higher measured calcium level but does little to solve the remainder of the conundrum. It seems that the lysine citrate combination exerts anticoagulation activity independent of the apparent calcium level. That is, lysine citrate is less effective at lowering the effective calcium level than is sodium citrate. When lysine citrate is introduced into patient circulation either through transfusion of anticoagulated blood products or by means of the return stream in a plasmapheresis or similar “pheresis” instrument, it will have much less of an effect on calcium levels in circulation than equivalent amounts of citrate with other counterions. This is an indication that lysine citrate is a unique compound and behaves differently than a simple salt of citrate. Thus, another advantage of lysine citrate is enhanced patient safety and a simpler plasmapheresis set up since it will not longer be necessary to administer protective doses of calcium.

TABLE 12
Level of calcium measured in various citrate anticoagulants

| Citrate Level | Lysine Citrate | Sodium Citrate |
|---|---|---|
| 1% | 0.4 mg/dl | 0 mg/dl |
| 0.5% | 1.6 mg/dl | 0.6 mg/dl |
| 0.25% | 4.8 mg/dl | 2.5 mg/dl |
| 0.1% | 7.1 mg/dl | 5.3 mg/dl |
| 0.05% | 9.1 mg/dl | 8.7 mg/dl |
| 0.01% | 9.2 mg/dl | 9.2 mg/dl |

Table 13 shows the effects of the different anticoagulants on red blood cell integrity over time. To judge red cell condition the blood was counted and various other measurements were taken initially and after 20 and 33 days of storage at 4° C. Apparent initial/differences in RBC counts are due to dilution caused by adding extra anticoagulant. Mean cell volume (MCV) is a red cell index that is a useful measure of red cell health. An increase in MCV indicates that the normally biconcave red cells are undergoing a change to a spherical shape occasioned by loss of cellular energy and general cellular senescence and damage. It is believed that a citrate level of at least about 1.0% by weight (i.e., more than two times the usual amount) is necessary to ensure against all activation of plasma proteins. These results show that sodium citrate levels of 0.75% by weight or higher also cause unacceptable swelling of red cells during storage. On the other hand, amino acid citrates, which are very effective anticoagulants, are also effective at preventing red cell damage.

TABLE 13

| | RBC (10⁶/μl) | MCV | MCV |
|---|---|---|---|
| Anticoagulant | Day 1 | Day 20 | Day 33 |
| Na Citrate | 5.43 | 97.1 | 94.3 |
| 0.65 wgt %. | | | |
| Na Citrate | 5.86 | 98.7 | 103.2 |
| 0.75 wgt %. | | | |
| Na Citrate | 6.07 | 97.8 | 103.3 |
| 0.90 wgt %. | | | |
| Arg Citrate | 5.77 | 93.1 | 93.5 |
| 0.65 wgt %. | | | |
| Arg Citrate | 6.45 | 92.6 | 93.6 |
| 0.75 wgt %. | | | |
| Arg Citrate | 6.77 | 91.5 | 92.4 |
| 0.90 wgt %. | | | |
| Lys Citrate | 5.37 | 93.0 | 93.8 |
| 0.65 wgt %. | | | |
| Lys Citrate | 6.78 | 92.7 | 92.7 |
| 0.75 wgt %. | | | |
| Lys Citrate | 5.82 | 92.2 | 92.9 |
| 0.90 wgt %. | | | |

These results demonstrate an entirely new anticoagulant system that will result in revised Blood Bank procedures. The goal should be to collect blood into an elevated (compared to traditional anticoagulants) level of amino acid citrate. The citrate level should be between about 0.8 and 1.5% citrate (citric acid) by weight with sufficient amino acid to adjust the pH and prevent cell damage. The precise ratio of citrate to amino acid can be altered to adjust the pH of the solution. The actual level of citrate can be higher, but there appears to be little advantage to increased levels above about 1.5% by weight except for the case of platelets where 2% or higher amino acid citrate results in improved antibacterial activity. Similarly, the level can be somewhat lower than 0.8% by weight but the possibility for cryptic activation increases at lower levels. As already explained, the amino acid citrate solution can advantageously be used as an additive to improve the preservation of blood collected into the usual sodium citrate anticoagulant.

It is envisioned that the other usual additives such as phosphate and dextrose would be included. The higher level of citrate will prevent any cryptic activation of plasma proteins. If platelet concentrates are produced from blood treated with the new anticoagulants, the elevated citrate will preserve the platelets and prevent bacterial growth and/or kill bacteria yielding a platelet concentrate having a room temperature life of at least seven days. Red blood cells separated from the blood will have greater stability and shelf life without freezing. Although bacterial growth at 4° C. (red cell storage temperature) is much slower than at room temperature, the amino acid citrate also inhibits low temperature bacterial growth and acts as extra insurance against inadvertent bacterial contamination.

The following Table 14 shows possible amino acid anticoagulant mixtures for use in a 500 ml blood collection bag. These are “1%” citrate formulae; it will be appreciated that the actual level of citrate can be adjusted within its useable range. For example, platelet solutions would advantageously contain at least 2% by weight citrate. It will also be appreciated by those of skill in the art that adjustments of pH or osmolality may be required for optimum results.

TABLE 14

| | Formula A | | Formula B | | Formula C | | Formula D | |
|---|---|---|---|---|---|---|---|---|
| Additive | 70 | ml | 70 | ml | 70 | ml | 70 | ml |
| Volume | | | | | | | | |
| Citric Acid | 5 | g | 5 | g | 5 | g | 5 | g |
| Lysine¹ | 12.5 | g | | | 12.5 | g | | |
| Arginine¹ | | | 15 | g | | | 15 | g |
| Adenine | | | | | 20 | mg | 20 | mg |
| Dextrose | 1.8 | g | 1.8 | g | 2.25 | g | 2.25 | g |
| Sodium | 155 | mg | 155 | mg | 155 | mg | 155 | mg |
| Phosphate | | | | | | | | |

¹Weights approximate; sufficient added to achieve desired pH.

In the cases where the collected blood is separated into a cellular component and a plasma component, the initial higher citrate level provides superior plasma by preventing cryptic activation with associated protein damage. One of the devices used in fractionation and purification of plasma proteins is the membrane filter which (depending on pore size) can be used to desalt, concentrate (diafiltration) or fractionate the proteins. A major problem with such membrane-based methods has been the clogging of membrane pores. This probably involves partial activation and resulting polymerization of some plasma proteins. Use of sufficient lysine citrate (amino acid citrate) significantly reduces the rate of membrane clogging, thereby providing an additional advantage to using the inventive compound.

Citrate Removal and Fractionation

In almost all cases the plasma will go though additional fractionation steps. The plasma can be frozen and fractionated according to the traditional schemes. However, there are significant advantages to adding additional sodium and/or potassium citrate to “citrify” the proteins and directly produce a “super-cryoprecipitate” according to U.S. Pat. No. 6,541,518. All of the usual products can be made from the super-cryoprecipitate. The cryo-depleted plasma that results is superior to ordinary depleted plasma because it has less fibrinogen than depleted plasma made according to the traditional methods. In addition, since cryptic activation was prevented, the depleted plasma has increased amounts of protease inhibitors and other labile plasma proteins. It is then possible to lower the citrate level and process the cryo-depleted plasma according to traditional fractionation techniques.

There are at least two viable methods for removing citrate from plasma or any of the fractions. The first method involves passing the plasma or plasma fraction through an anion exchange column containing a resin having affinity for the citrate anion. A number of anion exchange resins have significant citrate affinities so that if the plasma is passed through a column containing the chloride form of such a resin, passage will effectively exchange chloride for citrate. Most strong base anion exchange resins are ideal, but a number of weak base anion exchange resins are also effective. Those of skill in the art will be readily able to compute the optimum size of column to replace a given amount of citrate at a given flow rate. Alternatively, there are well-known methods for analyzing column effluent so that ideal operating conditions will be readily attained. It is important to recognize that whole plasma and certain plasma fractions remain capable of clot formation so that with such fractions care must be taken not to remove too much of the citrate. A second consideration is the fact that citrate may act as a significant buffer so that removal can result in pH changes.

A second effective method for removing citrate is to titrate the plasma or fraction with a soluble calcium salt—for example, calcium chloride. As calcium citrate is highly insoluble, there will be an almost quantitative conversion of calcium into calcium citrate, which can then be removed by filtration or centrifugation. Again, it is relatively simple to compute the calcium addition to leave adequate residual citrate to ensure lack of clot formation. The same caveats concerning pH changes apply here. Addition of calcium as a solution has the drawback of somewhat diluting the fraction; there is nothing to prohibit adding the calcium as a solid so that such dilution can be avoided. Once the excess citrate has been removed, traditional fractionation techniques may be employed.

There are some data that indicate that higher levels of citrate anticoagulation have advantages beyond avoiding cryptic activation. In the following experiment aliquots of plasma were either anticoagulated using traditional anticoagulants (0.4% w/v citrate) or “high citrate” (1% w/v citrate). Extra citrate was then added (U.S. Pat. No. 6,541,518) and samples were then cooled to yield super-cryoprecipitate. The super-cryoprecipitate is useful either for the “traditional” use as a source of clotting factors or for providing high quality fibrin “glue” or fibrin “sealant.” The higher level of fibrinogen—as compared to traditional cryoprecipitate—makes the sealant application especially attractive.

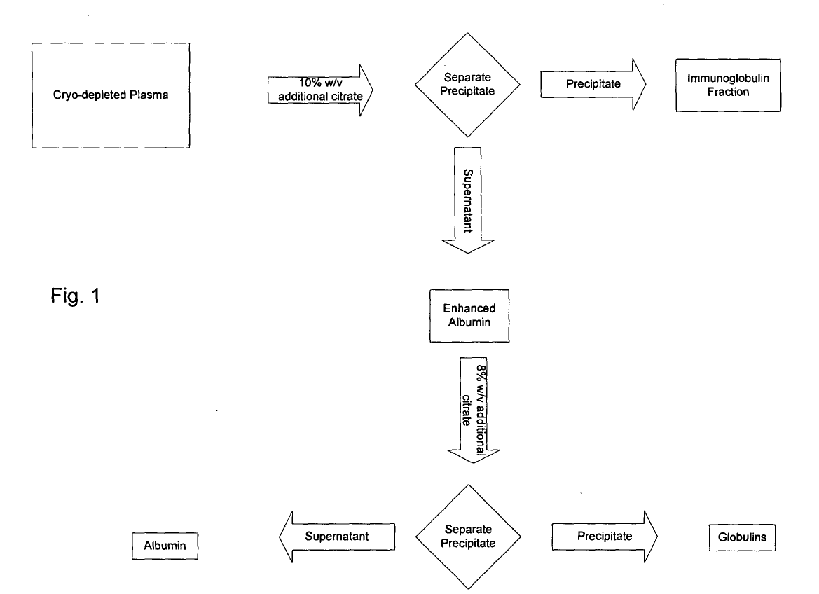

The cryo-depleted plasma remaining after the super-cryoprecipitate has been removed was further fractionated into an Enhanced Albumin fraction and an Immunoglobulin fraction. FIG. 1 shows the fractionation scheme. According to the figure cryo-depleted plasma (5-6% w/v citrate) is brought to higher citrate concentration through the addition of up to about 10% w/v citrate in the form or a soluble salt (i.e., sodium citrate). This increased level of citrate causes virtually 100% of the immunoglobulins to precipitate. Addition of too much citrate will cause the immunoglobulin fraction to be contaminated with other plasma proteins. Insufficient citrate will result in loss of immunoglobulins. The precipitated Immunoglobulin fraction (86%±13% IgG as measured by radial immunodiffusion) is recovered (centrifugation or filtration) and is redissolved in buffer. Protein electrophoresis of the Immunoglobulin fraction demonstrated that cross-contamination with other plasma proteins was low. In one experiment the fraction contained 84±14% IgG with other globulins (2%±1% alpha globulin and 4%±1% beta globulin) and albumin (10%±3. %). If a more pure immunoglobulin fraction is desired, traditional fractionation methods can be applied. Because the citrate fractionation avoids activation of proteins and alcohol denaturation of protein, superior fractionations can be achieved.

The supernatant remaining after removal of the immunoglobulins represents the enhanced albumin fraction, which contains (in one experiment) about 80±7% of the total amount of available albumin. This enhanced albumin fraction also contains are many of the useful alpha and beta globulins, particularly the protease inhibitors, α-1 antitrypsin, antithrombin III and α-1 antichymotrypsin, antiplasmin, ceruloplasmin which are all present at levels exceeding 90% of the original plasma values. If it is desired to separate these globulins from the albumin, one can add an addition amount of citrate (about 8.0% w/v) whereupon the globulins will precipitate and can be separated from the essentially pure albumin.

The fractions produced according to the method of FIG. 1 were challenged by inoculation with mixed bacterial inoculum A, B, or C which are listed in order of number of bacteria added—that is inoculum C contains more bacterial than inoculum A. After incubation for 12 hr samples were taken of each fraction and streaked onto nutrient agar plates. The plates were incubated and then scored for bacteria growth. The hypothesis tested is that cryptic activation of plasma depletes natural antibacterial constituents in the resulting fractions.

As shown in Tables 15 (inoculum A), 16 (inoculum B) and 17 (inoculum C), this hypothesis appears valid. In Table 15 none of the high citrate fractions (i.e., fractions produced from plasma anticoagulated with at least 0.8% w/v citrate) showed any bacterial growth. This indicates the presence of natural antibacterial substances in the fractions. That immunoglobulins would show antibacterial activity is not as surprising as the activity shown by cryoprecipitate and enhanced albumin. In contrast the low citrate fractions (i.e., fractions produced from plasma anticoagulated with the normal amount of citrate) failed to show antibacterial activity in the albumin fraction. This antibacterial activity could be very important for sepsis treatment where the toxin absorbing character of albumin could be enhanced by the inherent antibacterial properties. Table 16 shows that with inoculum B all the high citrate fractions continued to show no bacterial growth whereas both the cryoprecipitate and the Enhanced Albumin fraction of the low citrate showed bacterial growth. Table 17 shows that the extreme challenge of inoculum C produced bacterial growth in both the high and the low citrate fractions although there was less growth in the high citrate fractions.

TABLE 15

| | High Citrate | Low Citrate |
|---|---|---|
| Cryoprecipitate | no growth | no growth |
| Immunoglobulin | no growth | no growth |
| Albumin | no growth | ++ |

TABLE 16

| | High Citrate | Low Citrate |
|---|---|---|
| Cryoprecipitate | no growth | + |
| Immunoglobulin | no growth | no growth |
| Albumin | no growth | +++ |

TABLE 17

| | High Citrate | Low Citrate |
|---|---|---|
| Cryoprecipitate | +++ | ++++ |
| Immunoglobulin | + | ++++ |
| Albumin | ++++ | ++++ |

The modern blood banking procedures envisioned by the present invention start by collecting the blood into an enhanced amino acid citrate anticoagulant (an amino acid citrate additive can also be used following normal anticoagulation). This new anticoagulant prevents cryptic activation while preserving both red cells and platelets. At the same time bacterial growth is prevented—an especially important factor in providing platelet concentrates with longer shelf life. Plasma either with the cellular materials removed or plasma collected without cellular materials (e.g., by plasmapheresis) then benefits further from addition of even more citrate (in the form of the sodium or potassium salts) so that enhanced supercryoprecipitate can be generated. At the modern blood bank the enhanced supercryoprecipitate can be readily used to make as fibrin glue or sealant. The high levels of fibrin recovery make autologous fibrin sealant a distinct possibility for voluntary surgery. Not only does this represent increased safety for the patient, it also represents an important revenue source for the blood bank.

Plasma fractions locally produced from the cryo-depleted plasma can also generate revenue as well as enhancing the quality of patient care. The enhanced antibacterial characteristics make these fractions superior for essentially all patients. Because the improved anticoagulants and additives prevent cryptic activation, the Enhanced Albumin fraction has much higher levels of protease inhibitors (serpins) than traditional albumin fractions. Therefore, this fraction is ideal for patients with advanced liver disease-another way the modern blood bank can support the work of the hospital. Finally, the Immunoglobulin fraction can advantageously be used for treatment of a variety of infectious diseases. Fractionation of non-activated plasma produces superior fractions that are less likely to cause reactions, etc.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

I claim:

1. An improved method for stabilizing blood or a fraction thereof comprising the steps of adding sufficient solution comprising a mixture of a basic amino acid and citric acid to bring the final citrate concentration of said blood or fraction thereof to at least 0.8% by weight, wherein the basic amino acid is at a concentration sufficient to adjust the pH of the mixture to between about pH 6.0 and pH 8.0 and mixing the solution and the blood or fraction thereof completely.

2. The method according to claim 1, wherein the basic amino acid is selected from the group consisting of lysine and arginine.

3. The method according to claim 1, wherein the basic amino acid is at a concentration to adjust the pH of the mixture to about pH 7.0±0.1.

4. The method according to claim 1, wherein the final citrate concentration is between about 1% weight by volume and 2% weight by volume.

5. An aqueous composition comprising lysine and citric acid made by a process comprising the steps of adding sufficient lysine to a solution of citric acid to adjust the pH of the mixture to between about pH 6.0 and pH 8.0.

6. An improved method for stabilizing and preserving a platelet concentrate or platelet rich plasma comprising the steps of adding sufficient solution comprising a mixture of a basic amino acid and citric acid to bring the final citrate concentration of said platelet concentrate or platelet rich plasma to at least 0.8% by weight, wherein the basic amino acid is at a concentration sufficient to adjust the pH of the mixture to between about pH 6.0 and pH 8.0, and mixing the solution and the blood or fraction thereof completely.

7. The method according to claim 6, wherein the basic amino acid is selected from the group consisting of lysine and arginine.

8. The method according to claim 6, wherein the citrate concentration is between about 1% weight by volume. and 2% weight by volume.

9. An anticoagulant or additive for blood collection comprising a mixture of:
citric acid; and
a basic amino acid at a concentration sufficient to adjust the pH of the mixture to between about pH 6.0 and pH 8.0.

10. The anticoagulant or additive according to claim 9, wherein the basic amino acid is selected from the group consisting of lysine and arginine.

11. The anticoagulant or additive according to claim 9, further comprising dextrose.

12. The anticoagulant or additive according to claim 9, further comprising adenine.

13. A fractionation method for blood banks comprising the steps of:
providing anticoagulated blood or plasma;
producing cryoprecipitate from plasma by increasing the citrate level to at least about 10 weight % citrate;
separating cryoprecipitate from cryo-depleted plasma;
fractionating cryo-depleted plasma into an immunoglobulin and an albumin fraction.

14. The method according to claim 13. wherein the anticoagulated blood or plasma has a citrate concentration of at least about 0.8% weight by volume.

15. The method according to claim 13, wherein the step of collecting blood further comprises employing a basic amino acid-citrate composition.

16. The method according to claim 15, wherein the basic amino acid is selected from the group consisting of lysine and arginine.

17. The method according to claim 15, wherein the step of fractionating cryo-depleted plasma into an immunoglobulin and an albumin fraction comprises adding about 10% weight by volume citrate and separating a precipitated immunoglobulin fraction from a supernatant albumin fraction.

18. The method according to claim 17 further comprising the steps of adding about 8% weight by volume citrate to the albumin fraction and separating a precipitated alpha and beta globulin fraction from a supernatant albumin fraction.

19. The method according to claim 13, wherein the step of fractionating cryo-depleted plasma further comprises removal of citrate from the cryo-depleted plasma.

20. An improved preservative solution for biological fluids comprising:
citric acid sufficient to make a final citrate concentration of at least about 0.8% weight by volume when the improved preservative solution is added to a biological fluid; and
lysine sufficient to adjust the pH of the preservative solution to between about pH 6.0 and pH 7.0.
